(19) United States
(12) Patent Application Publication
(10) Pub. No.: US 2026/0225793 A1
(43) Pub. Date: Aug. 6, 2026

(54) AUTOMATED REEFER MANAGEMENT

(71) Applicant: Walmart Apollo, LLC, Bentonville, AR (US)

(72) Inventors: Abhijeet Prakash, Patna (IN); Pooja Kumari, Bangalore (IN); Pavan Kumar Reddy Boppidi, Bentonville, AR (US); Raju Chautagi, Bengaluru (IN); Tushar Advani, San Jose, CA (US); Najla Jannah Williams, Cypress, TX (US); Venkata Subramanian Madhu, Bangalore (IN); Praful Kumar Jha, Dwarka Mor (IN)

(73) Assignee: Walmart Apollo, LLC, Bentonville, AR (US)

(21) Appl. No.: 19/042,391

(22) Filed: Jan. 31, 2025

(51) Int. Cl. B65D 88/74; G05B 13/02; G06Q 10/0832

(52) U.S. Cl. CPC B65D 88/74; G05B 13/027; G06Q 10/0832

(57) ABSTRACT

A method can include receiving, from a first sensor, an ambient temperature indicative of an amount of external heat to which a first storage container is exposed. The method can also include determining, with a first machine learning model, a first set of pre-cooling parameters for the first storage container based in part on factors comprising the ambient temperature indicative of an amount of external heat to which a first storage container is exposed, time of day, and a scheduled loading time for the first storage container. The method can further include transmitting a first request to a first pre-cooling system to initiate a cooling process for the first storage container in accordance with the first set of pre-cooling parameters. The method can also include predicting maintenance of the first storage container using a second machine learning model. Other embodiments are described.

### FIELD OF THE DISCLOSURE

The present disclosure generally relates to automated reefer management.

### BACKGROUND

A significant challenge in the grocery industry is the efficient management of refrigerated containers (reefers) to ensure cold chain compliance. Key issues in managing reefers efficiently include optimizing fuel usage and timing. Additionally, general reefer management challenges encompass monitoring, preventative maintenance, and repairs. Given that reefers vary in dimensions, specifications, and have varying maintenance needs due to age, wear, dimensions and specifications, an automated reefer management system is desired.

### BRIEF DESCRIPTION OF THE DRAWINGS

The figures described below depict various aspects of the systems, methods, and non-transitory computer readable storage media disclosed therein. It should be understood that each figure depicts an embodiment of a particular aspect of the disclosed systems, methods, and non-transitory computer readable storage media, and that each of the figures is intended to accord with a possible embodiment thereof. Further, wherever possible, the following description refers to the reference numerals included in the following figures, in which features depicted in multiple figures are designated with consistent reference numerals.

There are shown in the drawings arrangements which are presently discussed, it being understood, however, that the present embodiments are not limited to the precise arrangements and are instrumentalities shown, wherein:

FIG. 1 illustrates a front elevation view of two computer systems that are suitable for implementing an embodiment of the system disclosed in FIG. 4;

FIG. 2 illustrates a representative block diagram of an example of the elements included in the circuit boards inside a chassis of the computer systems of FIG. 1;

FIG. 3 illustrates a diagram of a network, according to an embodiment;

FIG. 4 illustrates a system for automated reefer management, according to an embodiment;

FIG. 5 illustrates a flow chart for a method of automated reefer management, according to an embodiment;

FIG. 6 illustrates a flow chart for predicting the maintenance of a first storage container using a second machine learning model, according to an embodiment; and

FIG. 7. illustrates a graphical user interface, according to an embodiment.

The figures depict embodiments for purposes of illustration only. One skilled in the art will readily recognize from the following discussion that other embodiments of the systems, methods, and non-transitory computer-readable media storing computing instructions that are described herein can be employed without departing from the principles of the technology described herein.

### DETAILED DESCRIPTION

The present embodiments can generally relate to automated reefers. More specifically, various embodiments can include a method being implemented via execution of computing instructions configured to run on one or more processors and stored on one or more non-transitory computer-readable media. The method can include receiving, from a first sensor, an ambient temperature indicative of an amount of external heat to which a first storage container is exposed. The method can also include, determining, with a first machine learning model, a first set of pre-cooling parameters for the first storage container based in part on factors comprising the ambient temperature indicative of an amount of external heat to which a first storage container is exposed, time of day, and a scheduled loading time for the first storage container. The method can further include, transmitting a first request to a first pre-cooling system to initiate a cooling process for the first storage container in accordance with the first set of pre-cooling parameters. The method can also include predicting maintenance of the first storage container using a second machine learning model.

Other embodiments can include a non-transitory computer-readable medium storing computing instructions that, when executed on a processor, cause the processor to perform operations. The operations can include receiving, from a first sensor, an ambient temperature indicative of an amount of external heat to which a first storage container is exposed. The operations can also include, determining, with a first machine learning model, a first set of pre-cooling parameters for the first storage container based in part on factors comprising the ambient temperature indicative of an amount of external heat to which a first storage container is exposed, time of day, and a scheduled loading time for the first storage container. The operations can further include, transmitting a first request to a first pre-cooling system to initiate a cooling process for the first storage container in accordance with the first set of pre-cooling parameters. In some embodiments, the operations can also include predicting maintenance of the first storage container using a second machine learning model.

In other embodiments, a system can be provided. The system can include one or more local or remote processors or servers, mobile devices, smart glasses including augmented reality glasses, virtual reality headsets, mixed or extended reality headsets, and/or other electronic or electrical components, which can be in wired or wireless communication with one another. For instance, in one aspect, a computer system can include one or more local or remote processors and/or associated transceivers, along with one or more local or remote non-transitory computer-readable media storing computing instructions that, when run on the one or more processors, direct the one or more processors to perform one or more operations. The operations can include receiving, from a first sensor, an ambient temperature indicative of an amount of external heat to which a first storage container is exposed. The operations can also include, determining, with a first machine learning model, a first set of pre-cooling parameters for the first storage container based in part on factors comprising the ambient temperature indicative of an amount of external heat to which a first storage container is exposed, time of day, and a scheduled loading time for the first storage container. The operations can further include, transmitting a first request to a first pre-cooling system to initiate a cooling process for the first storage container in accordance with the first set of pre-cooling parameters. In some embodiments, the operations can also include predicting maintenance of the first storage container using a second machine learning model.

Advantages will become more apparent to those skilled in the art from the following description of the embodiments which have been shown and described by way of illustration. As will be realized, the present embodiments can be capable of other and different embodiments, and their details are capable of modification in various respects. Accordingly, the drawings and description are to be regarded as illustrative in nature and not as restrictive.

In some embodiments, the methods, systems, and non-transitory computer readable storage media can be used to pre-cool reefers according to various parameters so that the reefers are conditioned just in time for loading. This pre-cooling reduces the unnecessary consumption of fuel for cooling and minimizes the unnecessary wear of the reefers. This also reduces the amount of CO₂ emissions. As an example, a reefer can be a trailer or container used to contain or transport products.

In other embodiments, the methods, systems, and non-transitory computer readable storage media can be used to develop a real-time seamless two-way communication (remote monitoring) with one or more reefers so that operators can operate and track reefers remotely. Users no longer need to venture into a yard to physically operate the reefers.

In additional embodiments, the methods, systems, and non-transitory computer readable storage media can be used to provide real-time diagnostics and self-repair for the pre-cooling systems of the reefers. For example, the diagnosis can be a failing compressor because the reefers with the same or similar specification can be known to have their compressors fail after a similar amount of wear. A work order to proactively replace the compressor can be automatically generated and scheduled so that the time needed to diagnose the problem is reduced and so that the frequency of logistical problems due to an unexpectedly out-of-commission reefer also can be reduced.

In some embodiments, the methods, systems, and non-transitory computer readable storage media can be used to provide predictive maintenance for the pre-cooling systems of the reefers. For example, reefers of the same or similar specification can be known to have their compressors fail after a similar amount of wear. A work order to replace the compressor can be generated and scheduled to reduce the downtime of the reefer and also to minimize the damage of other components due to the reefer operating with a failing or failed compressor.

In other embodiments, the methods, systems, and non-transitory computer readable storage media can be used to reduce the cost of energy consumed by allowing the reefers to switch from diesel to electricity. This operational change can reduce the wear of a diesel generator used to power pre-cooling systems of the reefer(s).

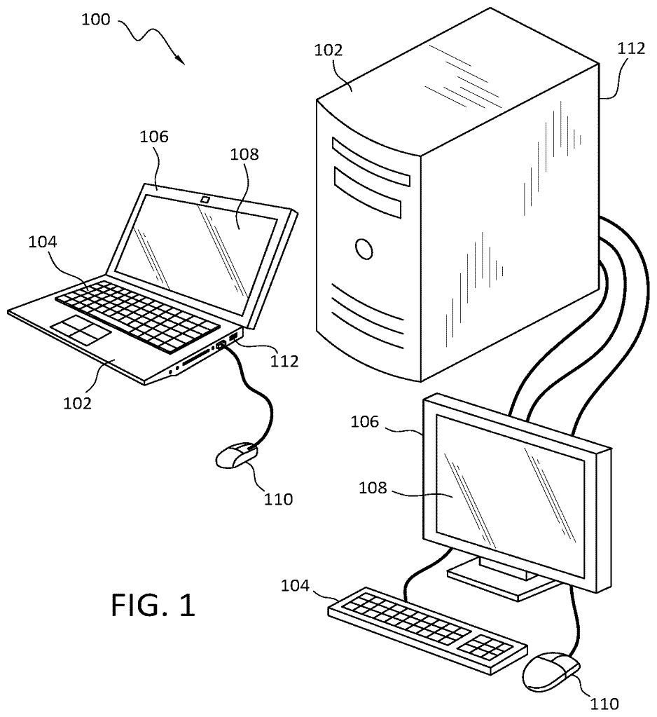

Turning to the drawings, FIG. 1 illustrates an embodiment of two different types (e.g., a laptop and a tower server) of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part, or all of, the techniques described herein. Computer system 100 can comprise chassis 102 containing one or more circuit boards (not shown) and one or more of an input/output port 112 (e.g., one or more universal serial bus (USB) ports of one or more types (e.g., USB type-A, type-B, type-C, micro-A, micro-B, mini-A, mini-B, etc.), one or more High-Definition Multimedia Interface (HDMI) ports, etc.).

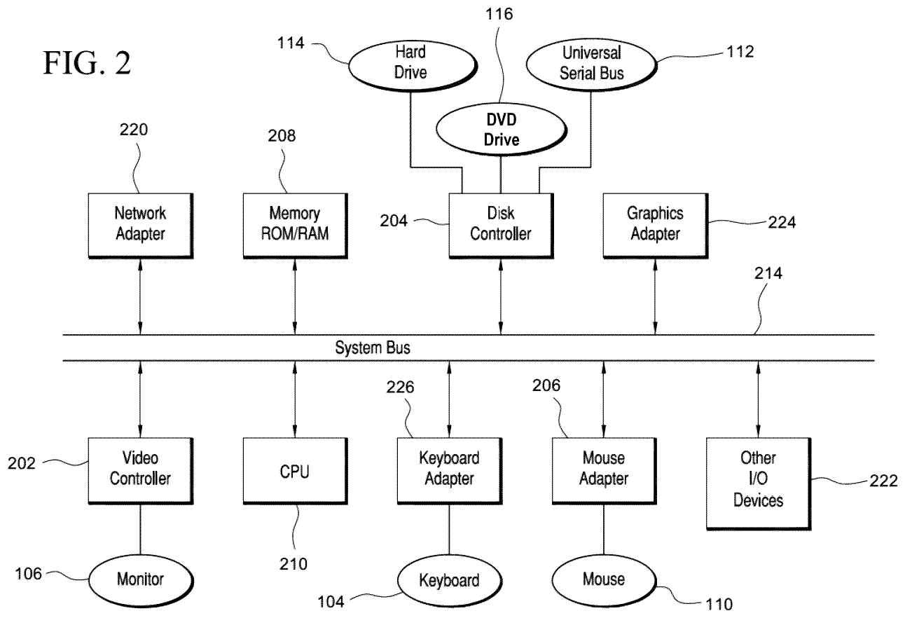

A representative block diagram of the elements included on the circuit boards inside chassis 102 is shown in FIG. 2. A central processing unit (CPU) 210 in FIG. 2 is coupled to a system bus 214. In various embodiments, the architecture of CPU 210 can be compliant with any of a variety of commercially distributed architecture families.

Continuing with FIG. 2, system bus 214 can also be coupled to memory storage unit 208 that includes both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to input/output port 112 (FIGS. 1-2)), hard drive 114 (FIG. 2), and/or one or more CD-ROM, DVD, Blu-Ray, or other suitable media, such as media configured to be used in a CD-ROM and/or DVD drive 116 (FIG. 2) inside chassis 102 (FIG. 1) or in a detachable drive coupled to input/output port 112.

Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Operating systems can include one or more of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS by The Open Group Ltd. of Reading, Berkshire in the United Kingdom, and (iv) Linux® OS by Linus Torvalds of Boston, Massachusetts, United State of America.

Further operating systems can comprise one of the following: (i) the iOS® operating system by Apple Inc. of Cupertino, California, United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, California, United States of America, (v) the Windows Mobile™ operating system by Microsoft Corp. of Redmond, Washington, United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O (input/output) devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 can be coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIG. 2), input/output port 112 (FIGS. 1-2), and CD-ROM and/or DVD drive 116 (FIG. 2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 by having wireless communication capabilities integrated into the motherboard chipset (not shown), and/or implemented via one or more dedicated wireless communication chips (not shown), connected through a PCI (peripheral component interconnector) or a PCI express bus of computer system 100 (FIG. 1) or input/output port 112 (FIG. 1). In other embodiments, network adapter 220 can comprise and/or be implemented as a wired network interface controller card (not shown).

Although many other components of computer system 100 are not shown, such components and their interconnection are well-known to those of ordinary skill in the art. Accordingly, further details concerning the construction and composition of computer system 100 and the circuit boards inside chassis 102 are not discussed herein.

When computer system 100 in FIG. 1 is running, program instructions stored on a USB drive in input/output port 112, on a CD-ROM or DVD in CD-ROM and/or DVD drive 116 (FIG. 2) or in the detachable CD-ROM and/or DVD drive coupled to input/output port 112, on hard drive 114 (FIG. 2), or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general purpose computer to a special purpose computer.

For purposes of illustration, programs and other executable program components are shown herein as discrete systems, although it is understood that such programs and components can reside at various times in different storage components of computer system 100, and can be executed by CPU 210. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 100 is illustrated as a laptop computer or a tower server in FIG. 1, there can be examples where computer system 100 can take a different form factor while still having functional elements similar to those described for computer system 100. In some embodiments, computer system 100 can comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 can comprise a portable computer, such as a laptop computer. In certain other embodiments, computer system 100 can comprise a mobile device, such as a smartphone, smart glasses, a virtual reality headset, augmented reality glasses, etc. In certain additional embodiments, computer system 100 can comprise an embedded system.

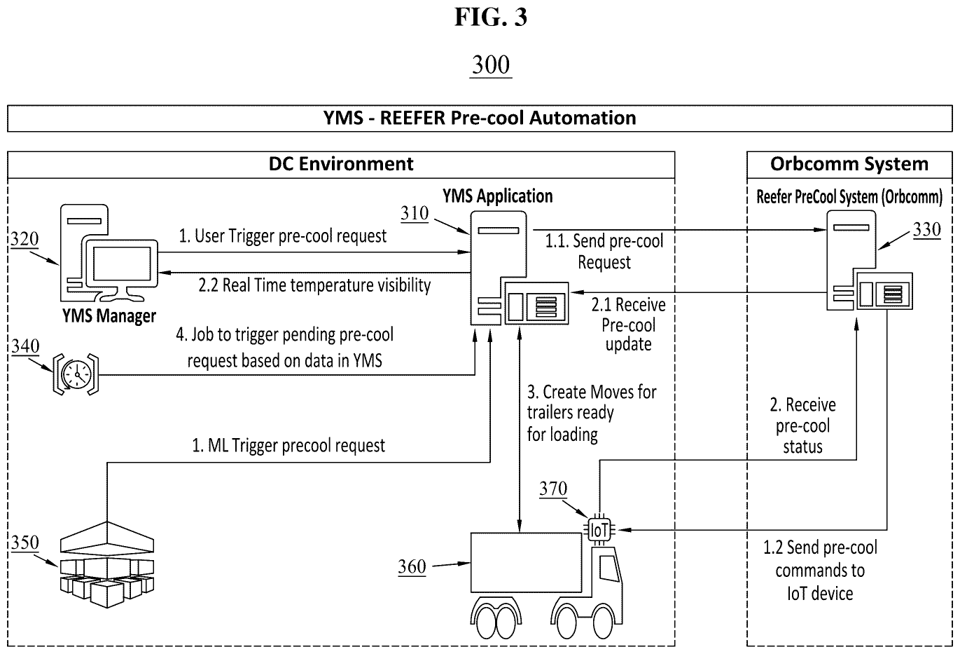

Turning ahead in the drawings, FIG. 3 illustrates a diagram of a network 300 for automated reefer management, according to various embodiments. Network 300 is an example, and embodiments of the system are not limited to the embodiments presented herein. The network can be employed in many different embodiments or examples not specifically depicted or described herein. In some embodiments, certain elements, modules, or systems of network 300 can perform various procedures, processes, operations, actions, and/or activities. In other embodiments, the procedures, processes, operations, actions, and/or activities can be performed by other suitable elements, modules, or systems of network 300.

System 310 in network 300 can run a yard management software (“YMS”) application. System 310 can send pre-cooling requests to System 330. System 310 can send real-time temperature visibility to System 320. System 310 can receive, from machine learning model 350, a trigger pre-cool request. System 310 can receive, from timer 340, a job to trigger a pending pre-cool request based on data in the yard management software. System 310 can also communicate with reefer(s) 360 to create moves for reefer(s) ready for loading. In some embodiments, System 310 can communicate directly with IoT (Internet of Things) device(s) 370 to send pre-cool requests and receive pre-cool update/status. Each reefer(s) 360 can have its own IoT device(s) 370.

System 320 in network 300 can run a yard management software manager. System 320 can send a user trigger pre-cool request to System 310 and receive telematics data from reefer(s) 360, including temperature data such as the ambient temperature of reefer(s) 360. System 320 can be operated by a user to trigger pre-cool requests to System 310 and to request telematics data from reefer(s) 360.

System 330 in network 300 can run pre-cooling software to monitor and communicate with IoT device(s) 370. System 330 can receive pre-cool request(s) from System 310 and send pre-cool update(s) to System 310. System 330 can also send pre-cool commands to IoT device(s) 370 and receive pre-cool update/status from IoT device(s) 370. System 330 can be an IoT management platform.

Timer 340 in network 300 can send triggers for pending pre-cool requests. Timer 340 can be configured to any time interval. For example, the interval at which triggers for pending pre-cool requests are to be sent can be 15 or 30 minutes.

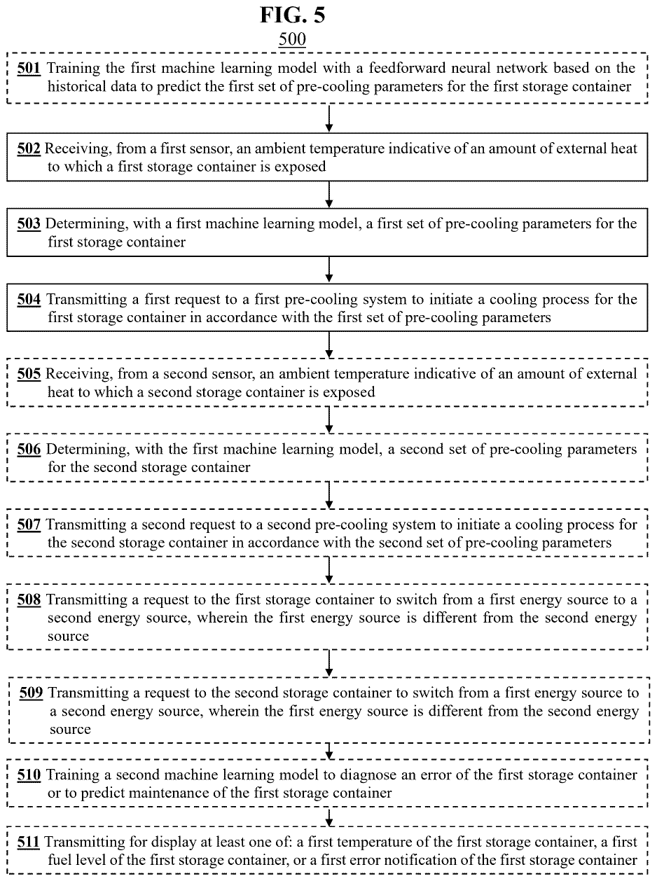

Machine learning model 350 in network 300 can send trigger pre-cool requests to System 310. The trigger pre-cool requests can include cooling parameters. In some embodiments, the machine learning model can be run on any system in network 300. An example implementation of machine learning model 350 is described further herein below with reference to method 500 (including e.g., block 501) and FIG. 5.

Reefer(s) 360 in network 300 can communicate with System 310 to create moves for reefer(s) 360 that are ready for loading.

IoT device 370 in the network 300 can receive pre-cool commands from System 330 and send a pre-cool status to System 330. In some embodiments, IoT device 370 can receive pre-cool commands from System 310 and send a pre-cool status to System 310.

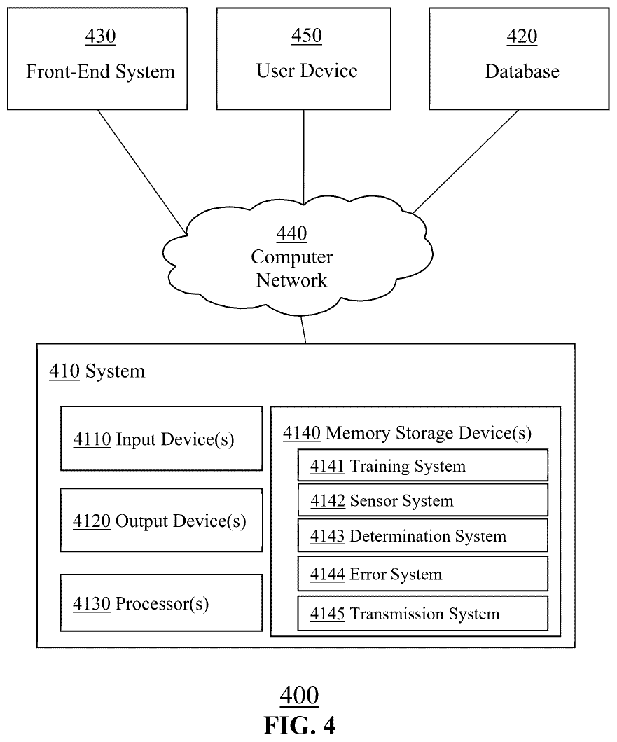

Turning ahead in the drawings, FIG. 4 illustrates a block diagram of a system 400 for automated reefer management, according to various embodiments. System 310, System 320 and/or System 330 can comprise System 400. System 400 is an example, and embodiments of the system are not limited to the embodiments presented herein. The System can be employed in many different embodiments or examples not specifically depicted or described herein. In some embodiments, certain elements, modules, or systems of System 400 can perform various procedures, processes, operations, actions, and/or activities. In other embodiments, the procedures, processes, operations, actions, and/or activities can be performed by other suitable elements, modules, or systems of System 400.

Generally, System 400 can be implemented with hardware and/or software, as described herein. In some embodiments part or all of the hardware and/or software can be customized (e.g., optimized) for implementing part or all of the functionality of System 400 described herein.

In some embodiments, System 400 can include a database 420 and a System 410. In the same or different embodiments, system 300 also can include a Front-End System 430, a Computer Network 440, and User Device 450.

In some embodiments, each of System 410, Database 420, Front-End System 430, and User Device 450 can include systems (training system 4141, sensor system 4142, determination system 4143, error system 4144, and/or transmission system 4145, as described further herein below) which may include computing instructions stored on non-transitory computer readable media and executable by one or more processors or may, in addition to or as an alternative, include a hardware device comprising electronic circuitry for implementing the functionality described below. In other embodiments, each of System 410, Database 420, Front-End System 430, and User Device 450 can be implemented in hardware, including ASICs (application specific integrated circuits) and the like.

In some embodiments, System 410 can comprise one or more systems, subsystems, modules, models, or servers (e.g., System 310 (FIG. 3), system 320 (FIG. 3), system 330 (FIG. 3), Timer 340 (FIG. 3), machine learning model 350 (FIG. 3), reefer(s) 360 (FIG. 3), IoT device(s) 370 (FIG. 3), etc.). System 410 and each of system 310 (FIG. 3), system 320 (FIG. 3), system 330 (FIG. 3), Timer 340 (FIG. 3), machine learning model 350 (FIG. 3), reefer(s) 360 (FIG. 3), and IoT device(s) 370 (FIG. 3) can be implemented, at least in part, in software and/or firmware stored in or loaded on an internal or remote memory storage device(s) and executed on a processor of System 410, System 310 (FIG. 3), system 320 (FIG. 3), system 330 (FIG. 3), Timer 340 (FIG. 3), machine learning model 350 (FIG. 3), reefer(s) 360 (FIG. 3), and/or IoT device(s) 370 (FIG. 3). In various embodiments, one or more of System 410, system 310 (FIG. 3), system 320 (FIG. 3), system 330 (FIG. 3), Timer 340 (FIG. 3), reefer(s) 360 (FIG. 3), and IoT device(s) 370 (FIG. 3) can include one or more of trained machine learning (ML) and/or artificial intelligence (AI) models (the ML/AI models). System 410 and each of system 310 (FIG. 3), system 320 (FIG. 3), system 330 (FIG. 3), Timer 340 (FIG. 3), machine learning model 350 (FIG. 3), reefer(s) 360 (FIG. 3), IoT device(s) 370 (FIG. 3) can be a standard component or a custom component used to implement a portion of the system, method, and/or non-transitory computer-readable medium, as described herein. Additional details regarding System 410, Server Database 420, Front-End System 430, Computer network 440, and User Device 450 are described herein.

In some embodiments, each of System 410, Server Database 420, Front-End System 430, and User Device 450 can be in data communication, through a computer network, a telephone network, or the Internet (e.g., computer network 440) with each other. In other embodiments, System 410, Server Database 420, Front-End System 430, and User Device 450 are in direct communication with each other using, for example, Bluetooth communication.

In some embodiments, each of System 410, Server Database 420, Front-End System 430, and User Device 450 can include one or more input devices, one or more output devices, one or more processors, and/or one or more memory storage devices. Examples of input devices can include one or more keyboards, one or more keypads, one or more pointing devices such as a computer mouse or computer mice, one or more touchscreen displays, a microphone, a camera, keyboard 104 (FIG. 1), mouse 110 (FIG. 1), etc. Examples of output devices can include one or more monitors, one or more touch screen displays, projectors, monitor 106 (FIG. 1), screen 108 (FIG. 1), etc. Other examples of output devices can include other I/O device 222 (FIG. 2), network adapter 220, wireless transmitters, wired transmitters, and the like. Examples of processors can include CPU 210 (FIG. 2), etc. Examples of memory storage devices can include memory storage unit 208 (FIG. 2), external storage units coupled to input/output port 112 (FIGS. 1-2), hard drive 114 (FIG. 2), CD-ROM and/or DVD drive 116 (FIG. 2), a detachable drive coupled to input/output port 112 (FIGS. 1-2), etc. In a number of embodiments, input devices further can include one or more cameras and/or one or more microphones. In the same or different embodiments, input devices can include one or more GPS (Global Positioning System) sensor(s), one or more accelerometers, and/or one or more gyroscopes.

Input devices and output devices can be coupled to their respective System 410, Server Database 420, Front-End System 430, and User Device 450 in a wired manner and/or a wireless manner, and the coupling can be direct and/or indirect, as well as locally and/or remotely. As an example of an indirect manner (which can or cannot also be a remote manner), a keyboard-video-mouse (KVM) switch can be used to couple an input device and an output device to a processor and/or a memory storage device, all of a particular user device. In a similar manner, the processors and/or memory storage devices of the user devices can be local and/or remote to each other.

In certain embodiments, the user device 450 can be mobile devices, and/or other endpoint devices used by one or more users. A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device (e.g., smart glasses, other smart jewelry, augmented-reality (AR) headsets, virtual-reality (VR) headsets, etc.), or another portable computer device with the capability to present audio and/or visual data (e.g., images, videos, music, etc.).

Mobile devices can include (i) an iPod®, iPhone®, iTouch®, iPad®, MacBook® or similar product by Apple Inc. of Cupertino, California, United States of America, (ii) a Blackberry® or similar product by Research in Motion (RIM) of Waterloo, Ontario, Canada, (iii) a Lumia® or similar product by the Nokia Corporation of Keilaniemi, Espoo, Finland, or (iv) a Galaxy™ Tab or Smartphone or similar product by the Samsung Group of Samsung Town, Seoul, South Korea. Further, in the same or different embodiments, a mobile device can include an electronic device configured to implement one or more of (i) the iPhone® operating system by Apple Inc. of Cupertino, California, United States of America, (ii) the Blackberry® operating system by Research In Motion (RIM) of Waterloo, Ontario, Canada, (iii) the Android™ operating system developed by the Open Handset Alliance, or (iv) the Windows Mobile™ operating system by Microsoft Corp. of Redmond, Washington, United States of America.

The one or more databases can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more databases, that particular database can be stored on a single memory storage unit or the contents of that particular database can be spread across multiple ones of the memory storage units storing the one or more databases, depending on the size of the particular database and/or the storage capacity of the memory storage units.

The one or more databases can each include a structured (e.g., indexed) collection of data and can be managed by any suitable database management systems configured to define, create, query, organize, update, and manage database(s). Database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, communications between one or more of System 410, Server Database 420, Front-End System 430, and User Device 450 can be implemented using any suitable manner of wired and/or wireless communication. Accordingly, System 410, Server Database 420, Front-End System 430, and User Device 450 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). PAN protocol(s) can include Bluetooth, Zigbee, Wireless Universal Serial Bus (USB), Z-Wave, etc.; LAN and/or WAN protocol(s) can include Institute of Electrical and Electronic Engineers (IEEE) 802.3 (also known as Ethernet), IEEE 802.11 (also known as WiFi), etc.; and wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc.

The specific communication software and/or hardware implemented can depend on the network topologies and/or protocols implemented, and vice versa. In some embodiments, communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further communication hardware can include wireless communication hardware including, for example, one or more radio transceivers, one or more infrared transceivers, etc. Additional communication hardware can include one or more networking components (e.g., modulator-demodulator components, gateway components, etc.).

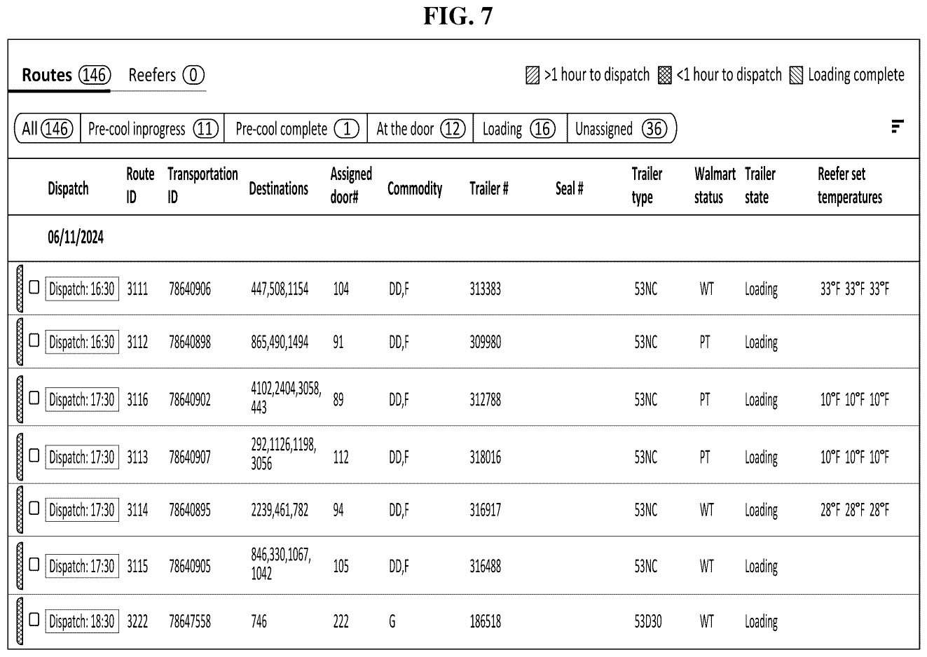

In some embodiments, System 410 can be configured to transmit, to a user device 450 of a user, or to a graphical user interface (e.g., a webpage, a graphical user interface of a mobile application, etc.) for display on the user device. The graphical user interface can include statistics, alerts, reefer status, reefer names, details of the reefers (specifications, last maintenance, etc) dispatch time, route ID, transportation ID, destinations, locations, assigned doors, types of commodity, reefer number/type, store status, reefer state, set temperature(s) (e.g., FIG. 7). The GUI is capable of filtering reefers by completion status, location status, load status, and whether the reefer is assigned. System 410, Server Database 420, Front-End System 430, and User Device 450 can determine, by using any suitable approaches or ML/AI models, the statistics, notices, augmented reality views, feedback, and other information. Algorithms for the ML/AI models for determining the information can include decision trees, K Nearest Neighbor (KNN), neural networks (e.g., feedforward neural network (FNN)), CatBoost, support vector machine, etc.

Turning ahead in the drawings, FIG. 5 illustrates a flow chart for a method 500 automated reefer management, according to one embodiment. Method 500 can be implemented via execution of computing instructions configured to run on one or more processors and stored on one or more non-transitory computer-readable media, and/or via one or more ASICs. Method 500 is merely an example and is not limited to the embodiments presented herein. Method 500 can be employed in many different embodiments or examples not specifically depicted or described herein.

In some embodiments, the procedures, the processes, the operations, the actions, and/or the activities of method 500 can be performed in the order presented. In other embodiments, the procedures, the processes, the operations, the actions, and/or the activities of method 500 can be performed in any suitable order. In still other embodiments, one or more of the procedures, the processes, the operations, the actions, and/or the activities of method 500 can be combined together or skipped.

In some embodiments, system 410 (FIG. 4) can be suitable to perform method 500 and/or one or more of the operations, actions, and/or activities of method 500. In these or other embodiments, one or more of the operations, actions, and/or activities of method 500 can be implemented as one or more computing instructions configured to run on one or more processors and configured to be stored on one or more non-transitory computer readable media, and/or as one or more ASICs. Such non-transitory computer readable media can be part of a computer system such as System 410, Database 420, Front-End System 430, and User Device 450. The processor(s) can be similar or identical to the processor(s) described above with respect to computer system 100 (FIG. 1).

Referring to FIG. 5, in some embodiments, method 500 can include a block 501 of training the first machine learning model with a feed forward neural network based on the historical data and characteristics of the first storage container to predict the first set of pre-cooling parameters for the first storage container. In some embodiments, the first set of pre-cooling parameters can include pre-cooling start time, a pre-cooling end time, a cooling temperature setting, and/or a pre-cooling duration. The first storage container can be any reefer. The machine learning model can consider multiple factors to predict pre-cooling parameters such as ambient temperature and other weather conditions, time of day, scheduled loading time, duration of the loading process, previous cooling history, location of the reefer, characteristics of the reefer, store needs, capacity of a reefer, type of goods to be placed into the reefer, dispatch time, amount of goods in a reefer (more goods require more cooling), etc. Historical data can include how many times the reefer has been cooled since the last maintenance event for the reefer and how many hours the reefer has been cooled for since the last maintenance event for the reefer. Characteristics of the reefer can include the volume of the reefer, the age of the reefer, and the characteristics of the pre-cooling system such as the cooling capacity, the efficiency rating, the airflow rate, the refrigerant type, and the operating temperature range.

Additionally, the machine learning model of block 501 can be trained to consider store needs. For example, reefers destined for stores with high or urgent needs should be prioritized when it comes to pre-cooling. Stores that don't have high needs (i.e., medium/low needs) can be deprioritized, optimizing the use of cooling resources. The machine learning model can also be trained to consider the capacity of a reefer. For example, when a reefer is to be fully loaded with goods, the reefer should be pre-cooled adequately to maintain the quality (e.g., temperature) of the goods. In contrast, reefers that are less than full may require less aggressive cooling, allowing for more flexible energy use. The machine learning model can also consider the type of goods being loaded/transported in the reefer. For example, the goods can be perishable items like dairy and/or produce, or they may be frozen items like ice cream, or they may be temperature-sensitive items such as candles or medicine. Dispatch time is when the reefer is to be dispatched. Ambient temperature indicates the amount of external heat to which the reefer is exposed. Higher ambient temperatures indicate more aggressive cooling strategies than lower ambient temperatures. The time of day and weather can affect ambient temperatures and operational schedules. For example, a sunny afternoon loading schedule can be hotter and require a more aggressive cooling strategy than a cloudy day or night-time loading schedule.

In some implementations, training the machine learning model at block 501 may include preprocessing training data (e.g., preprocessing the data to clean, normalize, and format it for analysis). The data of the factors received by the machine learning model can be preprocessed in one or more of the following ways:

| Data | Data Type | Preprocessing Detail(s) |
|---|---|---|
| Ambient | Continuous | Missing temperature values can be replaced with the mean |
| Temperature | | temperature for that time of the year. |
| Time of Day | Categorical | The feature can be extracted by extracting the hour (e.g., 0-23) |
| | | and categorizing the hour as Morning (e.g., 0-11), Afternoon (e.g., |
| | | 12-17), and/or evening (e.g., 18-23). |
| Scheduled | Timestamp | The timestamp can be transformed into a numerical format, such |
| Loading | | as total minutes from a baseline date. The hour can be extracted |
| Time | | from the scheduled loading time to capture patterns (e.g., morning |
| | | vs. afternoon). Weekly trends and patterns related to loading |
| | | efficiency can be identified by further creating a feature to |
| | | indicate the day of the week. The time difference between the |
| | | current time and the scheduled loading time can be calculated and |
| | | be represented in minutes and be used to determine the pre- |
| | | cooling parameters. |
| Cooling | Continuous | Missing values can be replaced with the mean of the available |
| History | | data. The values can be scaled to a common range (e.g., 0 to 1) |
| | | $using Min - Max scaling ( e . g . , {X}_{s c a l e d} = \frac{{X}_{i} - {X}_{min}}{{X}_{max} - {X}_{min}} ) .$ |
| Store Needs | Categorical | Categorical values can be converted into a numerical format to |
| | | reflect an order of priority. For example, “High” can be “2”, |
| | | “Medium” can be “1”, and “Low” can be “0”. |
| Capacity | Categorical | Numerical values can be assigned to the categories to represent |
| (Store | | their capacity. For example, “Full” can be “2”, “Half ” can be “1”, |
| Needs) | | and “Empty” can be “0”. |
| Type of | Categorical | The categorical values can be converted into binary features. Each |
| Goods | | type of good can become a separate column, where a value of 1 |
| | | indicates the presence of that type and 0 indicates the absence of |
| | | that type. |
| Dispatch | Timestamp | The timestamp can be transformed into a numerical format, such |
| Time | | as total minutes from a baseline date. The hour can be extracted |
| | | from the scheduled loading time to capture patterns (e.g., morning |
| | | vs. afternoon). Weekly trends and patterns related to loading |
| | | efficiency can be identified by further creating a feature to |
| | | indicate the day of the week. For example, there can be higher |
| | | demands on certain days of the week. The time difference |
| | | between the current time and the scheduled loading time can be |
| | | calculated and be represented in minutes and be used to determine |
| | | the pre-cooling parameters. |

A feed forward neural network can be used to train the model based on the historical data and engineered features. For example:

$${h}_{j} = σ ( {\sum }_{i = 1}^{n} {W}_{i j} {x}_{i} + {b}_{j} )$$

wherein:
hⱼ is the activation of neuron j in the hidden layer.
wᵢⱼ are the weights connecting the input layer to the hidden layer.
bⱼ is the bias term for neuron j.
σ represents and activation function, for example, a rectified linear unit activation function (ReLU).

The target variable for training is when pre-cooling is needed and how much (time) is needed for pre-cooling. The output layer can comprise two outputs. One output can be a classification output (Y₁), indicating whether pre-cooling is needed. The output of the classification output can be binary (e.g., 0 or 1).

Another output can be the regression output (Y₂). The regression output can be a continuous value representing the estimated time required to pre-cool. The value of the regression output can represent minutes and/or hours and is not limited to minutes and/or hours.

For example, the classification output (whether pre-cooling is needed) can be represented as:

$${Y}_{1} = σ ( {\sum }_{j} {w}_{j 1} {h}_{j} + {b}_{1} )$$

wherein: Y₁ is a value between 0 and 1, representing the possibility/chance of pre-cooling being required. If Y₁>0.5, pre-cooling is triggered.

For example, the regression output (time required for pre-cooling) can be represented as:

$${Y}_{2} = {\sum }_{j} {w}_{j 2} {h}_{j} + {b}_{2}$$

wherein Y₂ represents the time required to complete the pre-cooling (in hours).

Referring to FIG. 5, in some embodiments, method 500 can include a block 502 of receiving, from a first sensor, an ambient temperature indicative of an amount of external heat to which a first storage container is exposed. For example, the amount of external heat can be measured with a thermometer.

Referring to FIG. 5, in some embodiments, method 500 can include a block 503 of determining, with a first machine learning model (e.g., trained via block 501), a first set of pre-cooling parameters for the first storage container. For example, all reefers that are eligible for pre-cooling can be identified. The pre-cooling algorithms which output the classification and regression outputs can be used on each individual reefer eligible for pre-cooling. For example, if the reefer eligible for pre-cooling is determined to require pre-cooling, the pre-cooling algorithm triggers the pre-cooling of the reefer. The first machine learning model can consider factors comprising ambient temperature indicative of an amount of external heat to which a storage container is exposed to, time of day, scheduled loading time for the storage container, store's needs (priority), a capacity of the storage container (how full is the storage container), cooling history of the storage container, and/or type of goods to be put into the store container.

Referring to FIG. 5, in some embodiments, method 500 can include a block 504 of transmitting a first request to a first pre-cooling system to initiate a cooling process for the first storage container in accordance with the first set of pre-cooling parameters. For example, the pre-cooling parameters can include a time to begin pre-cooling (e.g., now, in 1 hour, etc.), the amount of time to run pre-cooling, and the desired temperature to which the inside of the reefer should be cooled.

Referring to FIG. 5, in some embodiments, method 500 can include a block 505 of receiving, from a second sensor, an ambient temperature indicative of an amount of external heat to which a second storage container is exposed. For example, the amount of external heat can be measured with a thermometer.

Referring to FIG. 5, in some embodiments, method 500 can include a block 506 of determining, with the first machine learning model, a second set of pre-cooling parameters for the second storage container. For example, all reefers that are eligible for pre-cooling can be identified. The pre-cooling algorithms which output the classification and regression outputs can be used on each individual reefer eligible for pre-cooling. For example, if the reefer eligible for pre-cooling is determined to required pre-cooling, the pre-cooling algorithm triggers the pre-cooling of the reefer. The second set of pre-cooling parameters can be similar to the first set of pre-cooling parameters depending on ambient temperature and other weather conditions, time of day, scheduled loading time, duration of the loading process, historical data, location of the reefer, characteristics of the reefer, store needs, capacity of a reefer, type of goods to be placed into the reefer, dispatch time, etc.

Referring to FIG. 5, in some embodiments, method 500 can include a block 507 of transmitting a second request to a second pre-cooling system to initiate a cooling process for the second storage container in accordance with the second set of pre-cooling parameters. For example, the pre-cooling parameters can include a time to begin pre-cooling (e.g., now, in 1 hour, etc) and the amount of time to run pre-cooling.

Referring to FIG. 5, in some embodiments, method 500 can include a block 508 of transmitting a request to the first storage container to switch from a first energy source to a second energy source, wherein the first energy source is different from the second energy source. For example, the request can have the reefer switch from its diesel generator to an electric battery or another supplied electrical source.

Referring to FIG. 5, in some embodiments, method 500 can include a block 509 of transmitting a request to the second storage container to switch from a first energy source to a second energy source, wherein the first energy source is different from the second energy source. For example, the request can have the reefer switch from its diesel generator to an electric battery or another supplied electrical source.

Referring to FIG. 5, in some embodiments, method 500 can include a block 510 of training a second machine learning model to diagnose an error of the first storage container or the second storage container. The second machine learning model can be trained with an anomaly detection algorithm. For example, random forest can be used to detect anomalies. Historical sensor data, including normal and faulty operation states can be used to train the second machine learning model. The random forest can diagnose the error of the first storage container or the second storage container using factors comprising temperature (inside the reefer), humidity, refrigerant levels, pressure, and compressor status.

Sensors on the pre-cooling systems can continuously collect data. The data can be the temperature (of interior of the reefer), pressure (of the pre-cooling system), refrigerant levels, and compressor health. This data can be preprocessed to clean, normalize, and format it for the analysis of the second machine learning model. The features such as temperature, humidity, refrigerant levels, pressure, and compressor status, which are indicative of a pre-cooling system's health and performance can be extracted. The data collected from the sensors of the pre-cooling system and in the reefer for determining a potential cause of anomaly can be preprocessed as follows:

| Data | Data Type | Preprocessing Detail(s) |
|---|---|---|
| Temperature | Continuous | Missing values can be replaced with the mean of the available |
| (inside the | | data. The values can be scaled to a common range (e.g., 0 to 1) |
| reefer) | | $using Min - Max scaling ( e . g . , {X}_{s c a l e d} = \frac{{X}_{i} - {X}_{min}}{{X}_{max} - {X}_{min}} ) .$ |
| Humidity | Continuous | Missing values can be replaced with the mean of the available |
| | | data. The values can be scaled to a common range (e.g., 0 to 1) |
| | | $using Min - Max scaling ( e . g . , {X}_{s c a l e d} = \frac{{X}_{i} - {X}_{min}}{{X}_{max} - {X}_{min}} ) .$ |
| Refrigerant | Categorical | Numerical values can be converted into categorical values. For |
| Levels | | example, “Normal/Sufficient” can indicate that the pre-cooling |
| | | system has adequate refrigerate and can be represented as a 1 or |
| | | “Sufficient.” “Low/Insufficient” can indicate that the pre-cooling |
| | | system is low on refrigerate and can be represented as a 0 or |
| | | “Insufficient.” “Critical/Faulty” can indicate that the pre-cooling |
| | | system is critically low on refrigerant or has a leak and can be |
| | | represented as a 2 or “Critical.” |
| Pressure | Continuous | Missing values can be replaced with the mean of the available |
| | | data. The values can be scaled to a common range (e.g., 0 to 1) |
| | | $using Min - Max scaling ( e . g . , {X}_{s c a l e d} = \frac{{X}_{i} - {X}_{min}}{{X}_{max} - {X}_{min}} ) .$ |
| Compressor | Categorical | Categorical values can be converted into numerical values to |
| Status | | reflect the compressor status. For example, “0” can indicate that |
| | | the compressor is off (not operating). “1” can indicate that the |
| | | compressor is on (operating normally). “2” can indicate that the |
| | | compressor is in a faulty state or requires maintenance. |

The data collected from the sensors of the pre-cooling system and in the reefer for the prediction of maintenance can be preprocessed as follows:

| Data | Data Type | Preprocessing Detail(s) |
|---|---|---|
| Temperature | Continuous | Missing values can be replaced with the mean of the available |
| (inside the | | data. The values can be scaled to a common range (e.g., 0 to 1) |
| reefer) | | $using Min - Max scaling ( e . g . , {X}_{s c a l e d} = \frac{{X}_{i} - {X}_{min}}{{X}_{max} - {X}_{min}} ) .$ |
| Humidity | Continuous | Missing values can be replaced with the mean of the available |
| | | data. The values can be scaled to a common range (e.g., 0 to 1) |
| | | $using Min - Max scaling ( e . g . , {X}_{s c a l e d} = \frac{{X}_{i} - {X}_{min}}{{X}_{max} - {X}_{min}} ) .$ |
| Compressor | Categorical | Categorical values can be converted into numerical values. For |
| Status | | example, “0” can indicate that the compressor is off (not |
| | | operating). “1” can indicate that the compressor is on (operating |
| | | normally). “2” can indicate that the compressor is in a faulty state |
| | | or requires maintenance. |
| Fan Speed | Continuous | Missing values can be replaced with the mean of the available |
| | | data. The values can be scaled to a common range (e.g., 0 to 1) |
| | | $using Min - Max scaling ( e . g . , {X}_{s c a l e d} = \frac{{X}_{i} - {X}_{min}}{{X}_{max} - {X}_{min}} ) .$ |
| Vibration | Continuous | Missing values can be replaced with the mean of the available |
| Levels | | data. The values can be scaled to a common range (e.g., 0 to 1) |
| | | $using Min - Max scaling ( e . g . , {X}_{s c a l e d} = \frac{{X}_{i} - {X}_{min}}{{X}_{max} - {X}_{min}} ) .$ |

The machine learning model for predicting maintenance can be a Long Short-Term Memory (LSTM) recurrent neural network. The LSTM model can be trained with historical (sensor) data to learn temporal dependencies and recognize patterns/trends indicative of wear, tear, or potential failures to predict maintenance and determine potential cause of anomalies. The trained LSTM model can use real-time sensor data to predict the time to failure for components and the health of pre-cooling units. The LSTM model can also be continuously refined/retrained by utilizing feedback from maintenance activities and outcomes to improve the accuracy of future predictions. The LSTM model can predict maintenance using factors comprising temperature (inside the reefer), humidity, compressor status, fan speed, and vibration levels.

Referring back to FIG. 5, in some embodiments, method 500 can include a block 511 of transmitting for display at least one of: a first temperature of the first storage container, a first fuel level of the first storage container, or a first error notification of the first storage container. For example, the user can remotely access the status of the pre-cooling unit to view the internal temperature of the reefer and the fuel level of the reefer. Real-time alerts and notifications can be generated to inform the user of detected anomalies and self-repair actions. For example, the alert or notification can inform the user to add refrigerant to the pre-cool system of a reefer.

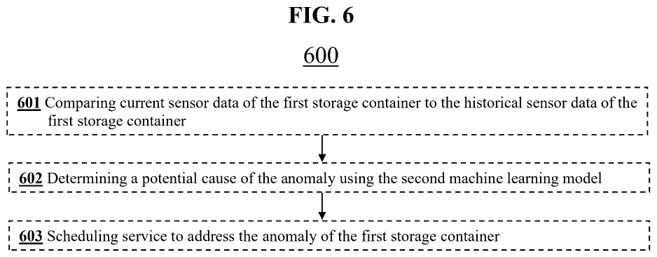

Turning ahead in the drawings, FIG. 6 illustrates a method 600, which can be a flow chart for step 510 of method 500 for automated reefer management, according to one embodiment. Method 600 can be implemented via execution of computing instructions configured to run on one or more processors and stored on one or more non-transitory computer-readable media, and/or via one or more ASICs. Method 600 is merely an example and is not limited to the embodiments presented herein. Method 600 can be employed in many different embodiments or examples not specifically depicted or described herein.

In some embodiments, the procedures, the processes, the operations, the actions, and/or the activities of method 600 can be performed in the order presented. In other embodiments, the procedures, the processes, the operations, the actions, and/or the activities of method 600 can be performed in any suitable order. In still other embodiments, one or more of the procedures, the processes, the operations, the actions, and/or the activities of method 600 can be combined together or skipped.

In some embodiments, system 410 (FIG. 4) can be suitable to perform method 600 and/or one or more of the operations, actions, and/or activities of method 600. In these or other embodiments, one or more of the operations, actions, and/or activities of method 600 can be implemented as one or more computing instructions configured to run on one or more processors and configured to be stored on one or more non-transitory computer readable media, and/or as one or more ASICs. Such non-transitory computer readable media can be part of a computer system such as System 410, Database 420, Front-End System 430, and User Device 450. The processor(s) can be similar or identical to the processor(s) described above with respect to computer system 100 (FIG. 1).

Referring to FIG. 6, in some embodiments, method 600 can include a block 601 of comparing current sensor data of the first storage container to the historical sensor data of the first storage container. The historical sensor data can be used to train the second machine learning model.

In some embodiments, method 600 can include a block 602 of determining a potential cause of the anomaly using the second machine learning model (e.g., the second machine learning model trained via block 510 of method 500). If an anomaly is detected, the machine learning model can provide insights into the potential cause of the fault based on feature importance analysis. For example, if a fault is detected in compressor health, the model may identify low refrigerant levels as a likely cause.

In some embodiments, method 600 can include a block 603 of scheduling service to address the anomaly of the first storage container. Pre-defined self-repair protocols can be automatically triggered based on the potential caused determined. For example, if low refrigerant levels are detected, the system automatically shuts down the pre-cooling unit to prevent damage and initiates a refill process. In some embodiments, maintenance technicians can remotely access the system to monitor the status of the pre-cooling unit and review diagnostic reports. In other embodiments, real-time alerts and notifications are generated to inform technicians and operators of detected anomalies and self-repair actions.

Turning ahead in the drawings, FIG. 7 illustrates a graphical user interface (GUI), according to one embodiment. In one embodiment, the status and information of a reefer can be displayed as a row. The status and information can include a dispatch time, a route ID, a transportation ID, an assigned door number, a commodity identifier/label, a trailer number, a seal number, the trailer type, a store status, a trailer state, and the temperature a reefer is set to. The displayed reefers can further be filtered depending on whether the pre-cooling of the reefer is in progress or completed. The displayed reefers can also be filtered depending on whether the reefer is at the door, being loaded, an unassigned. The filters can be combined in any combination.

Further, the status of each reefer can be color coded to reflect their time to dispatch or if they have completed loading. For example, yellow can reflect that a reefer has more than 1 hour until dispatch, red can reflect that the reefer has less than 1 hour until dispatch, and green can reflect that the reefer has completed loading.

In some embodiments, the steps performed on the first storage container can also be performed on a second storage container in the same/similar manner as described for the first storage container/reefer.

In a number of embodiments where one or more ML/AI models are used further can include pre-training and/or re-training the trained ML/AI models based upon the feedback received from a system user or collected from various data sources, and/or synthesized training data. In these embodiments, the same or different ML/AI models can be used in one or more of the above-referenced blocks.

For each of the machine learning models to be retrained, the respective training datasets can be updated manually by a system user (e.g., an ML engineer, a data scientist, etc.) and/or automatically by a system (e.g., system 410 (FIG. 4)). The system user can select new training data from various data sources. The system can collect new training data based upon various criteria. In certain embodiments, historical input and/or output data of the model to be re-trained can be used for re-training the model. In several embodiments, the historical input and/or output data of the model can be selected based upon system performance and/or user feedback from the system user associated with the historical output data. In various embodiments, when more than one training dataset is used for the pre-training and/or re-training, the system (e.g., system 410 (FIG. 4)) can format or re-format the data of the more than one training dataset (especially when datasets are from different sources) so that the hierarchy, schema, and/or other aspects of the data of the more than one training dataset follow a common hierarchy, structure, schema, etc., and so that the data of the more than one training dataset can be more easily used to pre-train or re-train the one or more machine learning models. The system can pre-determine the common hierarchy, structure, schema, etc. As needed, the system can reformat the data from various training dataset into a common data format so that the data can be used properly and efficiently by the system.

In some embodiments, the machine learning models, AI algorithms, classifiers, etc. can be customized and/or fine-tuned for the user. For example, the customized classifiers can be stored locally on system 410 (FIG. 4). As another example, one or more of these customized classifiers can be trained and/or retrained remotely and stored locally (e.g., at system 410).

Examples of the algorithms used for the various ML/AI models for one or more of the above-mentioned procedures, processes, activities, actions, operations, and/or methods can include BERT (Bidirectional Encoder Representations from Transformers), LLM (Language Learning Models), Lambda, Palm, XLNet, GPT-3 (generative pre-training transformer), GPT-4, KNN (k-nearest neighbor), decision trees, linear regression, logistic regression, K-Means, neural networks (e.g., feedforward neural network (FNN)), fuzzy logic, GANs (generative adversarial networks), CTGAN (cloud transformer generative adversarial networks), CNNs (convolutional neural networks), VAEs (variational autoencoder), and so forth. In various embodiments, each of the ML/AI models used can be trained and/or retrained dynamically and/or regularly.

In some embodiments, the systems and/or methods can be configured to train or re-train the one or more ML/AI models. The training of each of the ML/AI models can be supervised, semi-supervised, and/or unsupervised-which in some embodiments can be followed by, or used in conjunction with, other techniques, such as re-enforcement machine learning techniques, or other techniques utilized by ChatGPT-based voice bots or virtual assistants. The training data of training datasets for pre-training or re-training each of the ML/AI models can be collected from various data sources, including historical input and/or output data by the ML/AI model. The collection and update of the training data in the training datasets can be performed once, periodically (e.g., every day, every week, etc.), or constantly. For example, in certain embodiments, the input and/or output data of an ML/AI model can be curated by a user (e.g., an ML engineer, a data scientist, etc.) or automatically collected every time the ML/AI model generates new output data to update the training datasets for re-training the ML/AI model. In some embodiments, the trained and/or re-trained ML/AI model as well as the training datasets can be stored in, updated, and accessed from a database. In the same or different embodiments, when more than one training dataset is used for the pre-training and/or re-training, the data of the more than one training dataset can be formatted or reformatted so that the hierarchy, schema, and/or other aspects of the data of the more than one training dataset (especially when datasets are from different sources) follow a common hierarchy, structure, schema, etc., and so that the data of the more than one training dataset can be more easily used to pre-train or re-train the one or more machine learning models. In some embodiments, the common hierarchy, structure, schema, etc. can be predetermined.

In some embodiments, the users, systems, and/or methods further can determine whether to add the newly created historical input and/or output data to the training dataset for retraining the ML/AI models based upon user feedback and/or predetermined criteria. The user feedback can be associated with the output data of the ML/AI models or the output of the systems and/or methods using the ML/AI models.

In certain embodiments where machine learning techniques are not explicitly described in the processes, procedures, activities, operations, actions, and/or methods, such processes, procedures, activities, operations, actions, and/or methods can be read to include machine learning techniques suitable to perform the intended activities (e.g., determining, processing, analyzing, predicting, etc.). In several embodiments, the one or more ML/AI models can be configured to start or stop automatically upon occurrence of predefined events and/or conditions. In certain embodiments, the systems and/or methods can use a pre-trained ML/AI model, without any re-training.

Although systems and methods for collecting data have been described with reference to specific embodiments, it will be understood by those skilled in the art that various changes can be made without departing from the spirit or scope of the disclosure. Accordingly, the disclosure of embodiments is intended to be illustrative of the scope of the disclosure and is not intended to be limiting. For example, the systems, methods, and non-transitory computer readable storage media disclosed herein can diagnose an error of a reefer. In other use cases, the systems, methods, and non-transitory computer readable storage media disclosed herein can predict maintenance of a reefer. In further use cases, the systems, methods, and non-transitory computer readable storage media disclosed herein can automatically pre-cool a reefer at a determined time and for a determined duration.

It is intended that the scope of the disclosure shall be limited only to the extent required by the appended claims. For example, to one of ordinary skill in the art, it will be readily apparent that any element of FIGS. 1-6 can be modified, and that the foregoing discussion of certain of these embodiments does not necessarily represent a complete description of all possible embodiments. Additionally, one or more of the procedures, processes, operations, actions, and/or activities of the method in FIGS. 5-6 can include different procedures, processes, actions, and/or activities and be performed by many different systems, in many different orders. As an example, the modules, models, elements, and/or systems within network 300 and system 400 in FIGS. 3-4 can be interchanged or otherwise modified.

Replacement of one or more claimed elements constitutes reconstruction and not repair. Additionally, benefits, other advantages, and solutions to problems have been described with regard to specific embodiments. The benefits, advantages, solutions to problems, and any element or elements that can cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

As will be appreciated based upon the foregoing specification, the above-described embodiments of the disclosure can be implemented using computer programming or engineering techniques including computer software, firmware, hardware or any combination or subset thereof. Any such resulting program, having computer-readable code means, can be embodied, or provided within one or more computer-readable media, thereby making a computer program product, e.g., an article of manufacture, according to the discussed embodiments of the disclosure. The computer-readable media can be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code can be made and/or used by executing the code directly from one medium, by copying the code from one medium to another medium, or by transmitting the code over a network.

These computer programs (also known as programs, software, software applications, “apps,” or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor can include any programmable system including systems using micro-controllers, reduced instruction set circuits (RISC), application specific integrated circuits (ASICs), logic circuits, and any other circuit or processor capable of executing the functions described herein. The above examples are example only and are thus not intended to limit in any way the definition and/or meaning of the term “processor.”

As used herein, the terms “software” and “firmware” are interchangeable and include any computer program stored in memory for execution by a processor, including RAM memory, ROM memory, EPROM (erasable programmable read-only memory) memory, EEPROM (electrically erasable programmable read-only memory) memory, and non-volatile RAM (NVRAM) memory. The above memory types are example only and are thus not limiting as to the types of memory usable for storage of a computer program.

In one embodiment, a computer program is provided, and the program is embodied on a computer readable medium. In an embodiment, the system can be executed on a single computer system, without requiring a connection to a sever computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). The application is flexible and designed to run in various environments without compromising any major functionality. In some embodiments, the system includes multiple components distributed among a plurality of computing devices. One or more components can be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and preceded by the word “a” or “an” should be understood as not excluding plural elements, actions, operations, or steps, unless such exclusion is explicitly recited. Furthermore, references to “example embodiment” or “one embodiment” of the present disclosure are not intended to be interpreted as excluding the existence of additional embodiments that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

For simplicity and clarity of illustration, the drawing figures illustrate the general manner of construction, and descriptions and details of well-known features and techniques can be omitted to avoid unnecessarily obscuring the present disclosure. Additionally, elements in the drawing figures are not necessarily drawn to scale. For example, the dimensions of some of the elements in the figures can be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but can include other elements not expressly listed or inherent to such process, method, system, article, device, or apparatus.

The terms “couple,” “coupled,” “couples,” “coupling,” and the like should be broadly understood and refer to connecting two or more elements mechanically and/or otherwise. Two or more electrical elements can be electrically coupled together, but not be mechanically or otherwise coupled together. Coupling can be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, “approximately” may, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

This written description uses examples to disclose the disclosure, including the best mode, and to enable any person skilled in the art to practice the disclosure, including making and using any devices or computer systems and performing any incorporated computer-based or computer-implemented methods. The patentable scope of the disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system comprising:
a processor; and
a non-transitory computer-readable medium storing computing instructions configured to run on the processor and perform operations comprising:
receiving, from a first sensor, an ambient temperature indicative of an amount of external heat to which a first storage container is exposed;
determining, with a first machine learning model, a first set of pre-cooling parameters for the first storage container based in part on factors comprising the ambient temperature indicative of an amount of external heat to which a first storage container is exposed, time of day, and a scheduled loading time for the first storage container; and
transmitting a first request to a first pre-cooling system to initiate a cooling process for the first storage container in accordance with the first set of pre-cooling parameters.

2. The system of claim 1, wherein the operations further comprise:
training the first machine learning model with a feedforward neural network with at least historical data to predict the first set of pre-cooling parameters for the first storage container, wherein the first set of pre-cooling parameters comprise a pre-cooling start time and a pre-cooling duration.

3. The system of claim 1, wherein:
the factors further comprise store needs, an amount of goods, a cooling history of the first storage container, a type of goods, and a dispatch time.

4. The system of claim 1, wherein the operations further comprise:
transmitting, to the first pre-cooling system of the first storage container, the first set of pre-cooling parameters.

5. The system in claim 4, wherein the operations further comprise:
receiving, from a second sensor, an ambient temperature indicative of an amount of external heat to which a second storage container is exposed;
determining, with the first machine learning model, a second set of pre-cooling parameters for the second storage container based in part on (a) the ambient temperature indicative of an amount of external heat to which a second storage container is exposed, the time of day, and a scheduled loading time for the second storage container; and
transmitting a second request to a second pre-cooling system to initiate a cooling process for the second storage container in accordance with the second set of pre-cooling parameters.

6. The system of claim 1, wherein the operations further comprise:
transmitting a request to the first storage container to switch from a first energy source to a second energy source, wherein the first energy source is different from the second energy source.

7. The system of claim 1, wherein the operations further comprise:
training a second machine learning model to diagnose an error of the first storage container or to predict maintenance of the first storage container.

8. The system in claim 7, wherein the operations further comprise:
predicting the maintenance using the second machine learning model, comprising:
comparing current sensor data of the first storage container to historical sensor data of the first storage container;
when the second machine learning model detects an anomaly in the current sensor data of the first storage container, determining a potential cause of the anomaly using the second machine learning model; and
scheduling service to address the anomaly of the first storage container.

9. The system in claim 8, wherein the service is preventative maintenance.

10. The system of claim 1, wherein the operations further comprise:
transmitting for display, on a user device, at least one of:
a first temperature of the first storage container;
a first fuel level of the first storage container; or
a first error notification of the first storage container.

11. A method comprising:
receiving, from a first sensor, an ambient temperature indicative of an amount of external heat to which a first storage container is exposed;
determining, with a first machine learning model, a first set of pre-cooling parameters for the first storage container based in part on factors comprising the ambient temperature indicative of an amount of external heat to which a first storage container is exposed, a time of day, and a scheduled loading time for the first storage container;
transmitting a first request to a first pre-cooling system to initiate a cooling process for the first storage container in accordance with the first set of pre-cooling parameters; and
predicting maintenance of the first storage container using a second machine learning model.

12. The method of claim 11, further comprising:
training the first machine learning model with a feedforward neural network with at least historical data to predict the first set of pre-cooling parameters for the first storage container, wherein the first set of pre-cooling parameters comprise a pre-cooling start time and a pre-cooling duration.

13. The method of claim 11, wherein:
the factors further comprise store needs, an amount of goods, a cooling history of the first storage container, a type of goods, and a dispatch time.

14. The method of claim 11, further comprising:
transmitting, to the first pre-cooling system of the first storage container, the first set of pre-cooling parameters.

15. The method in claim 14, further comprising:
receiving, from a second sensor, an ambient temperature indicative of an amount of external heat to which a second storage container is exposed;
determining, with the first machine learning model, a second set of pre-cooling parameters for the second storage container based in part on (a) the ambient temperature indicative of an amount of external heat to which a second storage container is exposed, the time of day, and a scheduled loading time for the second storage container; and
transmitting, to a second pre-cooling system for the second storage container:
the second set of pre-cooling parameters; and
a second request to the second pre-cooling system to initiate a cooling process for the second storage container in accordance with the second set of pre-cooling parameters.

16. The method of claim 11, further comprising:
transmitting a request to the first storage container to switch from a first energy source to a second energy source, wherein the first energy source is different from the second energy source.

17. The method of claim 11, further comprising:
training a second machine learning model to diagnose an error of the first storage container or to predict maintenance of the first storage container.

18. The method in claim 17, wherein predicting the maintenance comprises:
predicting the maintenance using the second machine learning model, comprising:
comparing current sensor data of the first storage container to historical sensor data of the first storage container;
when the second machine learning model detects an anomaly in the current sensor data of the first storage container, determining a potential cause of the anomaly using the second machine learning model; and
scheduling service to address the anomaly of the first storage container.

19. The method in claim 11, further comprising at least one of:
(a): predicting the maintenance using the second machine learning model, comprising:
comparing current sensor data of the first storage container to historical sensor data of the first storage container;
when the second machine learning model detects an anomaly in the current sensor data of the first storage container, determining a potential cause of the anomaly using the second machine learning model; and
scheduling preventative maintenance the anomaly of the first storage container; or
(b): transmitting for display, on a user device, at least one of:
a first temperature of the first storage container;
a first fuel level of the first storage container; or
a first error notification of the first storage container.

20. A non-transitory computer readable storage medium storing one or more computing instructions that, when run on one or more processors, cause the one or more processors to perform:
receiving, from a first sensor, an ambient temperature indicative of an amount of external heat to which a first storage container is exposed;
determining, with a first machine learning model, a first set of pre-cooling parameters for the first storage container based in part on factors comprising the ambient temperature indicative of an amount of external heat to which a first storage container is exposed, time of day, and a scheduled loading time for the first storage container;
transmitting a first request to a first pre-cooling system to initiate a cooling process for the first storage container in accordance with the first set of pre-cooling parameters; and
predicting maintenance of the first storage container using a second machine learning model.
